(19) United States
(12) Patent Application Publication
(10) Pub. No.: US 2009/0082506 A1
(43) Pub. Date: Mar. 26, 2009

(54) Single-Constituent Polyorganosiloxane Composition Crosslinkable By Condensation And Comprising A Filler

(75) Inventors: Pascale Monti, Irigny (FR); Marc Chaussade, Villeurbanne (FR); Christine Prebet, Taluyers (FR)

Correspondence Address: BUCHANAN, INGERSOLL & ROONEY PC, POST OFFICE BOX 1404, ALEXANDRIA, VA, 22313-1404, US

(73) Assignee: BLUESTAR SILICONES FRANCE SAS, Lyon (FR)

(21) Appl. No.: 11/794,087

(22) PCT Filed: Dec. 22, 2005
(86) PCT No.: PCT/FR2005/003248

§ 371 Date: Sep. 29, 2008

(30) Foreign Application Priority Data
Dec. 23, 2004 (FR) 0413851

(51) Int. Cl. C08L 83/06; C08K 3/26

(52) U.S. Cl. 524/425; 524/588

(57) ABSTRACT

The invention concerns a single-constituent polycondensation polyorganosiloxane composition comprising a filler. The invention concerns single-constituent polyorganosiloxane (POS) compositions storage-stable in the absence of humidity and crosslinkable, in the presence of water, into elastomer, compositions comprising at least one crosslinkable linear polyorganopolysiloxane POS, a filler and a crosslinking catalyst, the POS having alkoxy, oxime, acyl and/or enoxy, preferably alkoxy, ends, and the composition being essentially free of hydroxylated POS at the ends and the catalyst comprising a vanadium compound and a titanium compound.

The invention relates to single-component silicone compositions comprising a filler, which are stable in storage in the absence of moisture and crosslink into an elastomer by means of polycondensation at ambient temperature (for example 5 to 35° C.) and in the presence of water (for example ambient moisture). Compositions such as these are sometimes referred to as CVE-1, which stands for single-component cold vulcanisable elastomers.

The formulation of cold vulcanisable elastomers by means of polycondensation generally involves a silicone oil, generally polydimethylsiloxane (PDMS) having hydroxylated ends optionally pre-functionalised by a silane so that they have Si(OR)ₐ ends, a crosslinking agent R_{b}Si(OR′)_{4-b} where b<3, a polycondensation catalyst, conventionally a tin salt or an alkyl titanate, a reinforcing filler and other optional additives such as fillers, adhesion promoters, colourings, biocidal agents, etc. During crosslinking, atmospheric moisture makes it possible for the polycondensation reaction to take place, and this leads to the formation of the elastomer network.

Elastomers such as these can be used in a wide range of applications, such as for gluing, waterproofing and moulding. The greatest market opportunities are represented by single-component (CVE-1) products in the form of sealants, adhesives or coatings which crosslink by means of moisture in the air.

CVE-1s of this type are used, inter alia, as a sealing, jointing and/or assembly means in particular in construction, the automotive industry and the household-appliance industry. The rheological properties of these single-component silicone materials (in paste form) have been the focus of much attention in these applications. The same applies to their resistance to weathering and heat, their flexibility at low temperature, their ease of use and the rapid crosslinking/hardening in situ on contact with moisture in the air.

When curing, the material initially forms a surface skin (surface curing, the speed of which is measured by the skin formation time SFT), and crosslinking subsequently continues to the core until hardening is complete (core curing). Cure kinetics are an essential criterion of CVE-1. There is thus great interest in having compositions with a crosslinkable core having cure kinetics which are as rapid as possible.

Crosslinking catalysts which are conventionally used are titanium compounds or vanadium compounds. Titanium compounds are known to result in compositions having a slow surface cure rate. More rapid surface curing is known to occur using compounds of vanadium. However, the curing of the core is not always optimal. The present inventors have discovered, in particular, that the presence of a carbonate-based filler interferes with the crosslinking of a CVE-1 composition catalysed by a vanadium compound. This interference translates in particular to a slow rate of core curing.

In addition, the CVE-1s which have alkoxy reactive groups have crosslinking kinetics which are much slower than CVE-1 s having acetic or oxime reactive groups.

The object of the invention is thus to propose a solution to these problems, so as to provide single-component silicone compositions having a filler, including a carbonate-based filler, which is able to crosslink into an elastomer in good conditions by polycondensation at ambient temperature and in the presence of moisture.

A further object of the invention is to accelerate the crosslinking kinetics of CVE-1s having alkoxy type reactive groups.

Among other things, the compositions according to the invention must be able to crosslink with rapid cure kinetics, including rapid surface cure kinetics and good core curing. In particular, a skin formation time of less than 15 minutes, preferably less than or equal to 10 minutes is envisaged.

A further object of the invention is to propose a composition of the type that does not release toxic volatile product during crosslinking.

These objects, and others, are achieved by the combined use of a vanadium compound and a titanium compound as the catalyst or the accelerator of the crosslinking reaction of a polyorganosiloxane composition (POS) which is stable in storage in the absence of moisture, comprising a filler and crosslinking to form an elastomer in the presence of water, in which composition the POS are non-hydroxylated crosslinkable linear POS and have functionalised ends of the alkoxy, oxime, acyl and/or enoxy type, preferably alkoxy type. The invention does not rule out the presence of a minority proportion of POS comprising OH groups, i.e. a proportion which accounts for less than 10 μmol of OH per g of the composition. In fact, these POS can be produced by a functionalisation reaction involving a POS having hydroxylated ends with a suitable crosslinking agent in the presence of a functionalisation catalyst, and some POS chains having hydroxylated ends may still remain. Preferably, the POS according to the invention are entirely free of hydroxylated ends.

The invention accordingly relates to a single-component polyorganosiloxane (POS) composition which is stable in storage in the absence of moisture and crosslinks into an elastomer in the presence of water, the composition comprising at least one crosslinkable linear polyorganopolysiloxane POS, a filler (a reinforcing and/or semi-reinforcing and/or non-reinforcing filler) and a crosslinking catalyst, the POS having non-hydroxylated functionalised ends, in particular ends of the alkoxy, oxime, acyl and/or enoxy type, preferably alkoxy type, the composition being basically or entirely free of hydroxylated POS, i.e. in particular having less than 10 μmol of OH per g of the composition, and being characterised in that the catalyst comprises a vanadium compound and a titanium compound.

The titanium and vanadium compounds act in a synergistic manner and result in rapid surface and core curing kinetics, even when the POS is of the alkoxy type and/or a semi-reinforcing filler of the carbonate type is present.

In a preferred embodiment, the said composition is characterised in that it comprises:

A—at least one crosslinkable linear polyorganopolysiloxane A of formula:

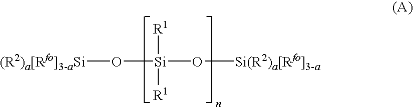

in which:
the substituents R¹ are the same or different and each represent a monovalent saturated or unsaturated C₁ to C₁₃ hydrocarbon radical which may be substituted or unsubstituted, aliphatic, cyclanic or aromatic;
the substituents R² are the same or different and each represent a monovalent saturated or unsaturated C₁ to C₁₃ hydrocarbon radical which may be substituted or unsubstituted, aliphatic, cyclanic or aromatic;
the functionalisation substituents R^{fo} are the same or different and each represent:
   an oxime radical of formula:

(R³)₂C═N—O—
wherein R³ independently represents a linear or branched C₁ to C₈ alkyl; a C₃ to C₈ cycloalkyl, a C₂ to C₈ alkenyl, preferably selected from the group comprising: methyl, ethyl, propyl, butyl, vinyl, allyl;
an alkoxy radical of formula:

R⁴O(CH₂CH₂O)_{b}—
wherein R⁴ independently represents a linear or branched C₁ to C₈ alkyl; a C₃ to C₈ cycloalkyl, preferably selected from the group comprising: methyl, ethyl, propyl, butyl, methylglycol, and b=0 or 1;
an acyl radical of formula:

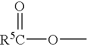

wherein R⁵ represents a monovalent saturated or unsaturated C₁ to C₁₃ hydrocarbon radical which may be branched or unbranched, substituted or unsubstituted, aliphatic, cyclanic or aromatic,
an enoxy radical of formula:

R⁶R⁶C═CR⁶—O—
wherein R⁶ are the same or different and represent a hydrogen or a monovalent saturated or unsaturated C₁ to C₁₃ hydrocarbon radical which may be branched or unbranched, substituted or unsubstituted, aliphatic, cyclanic or aromatic,
n has sufficient value to give POS A a dynamic viscosity of from 500 to 1,000,000 mPa·s at 25° C.;
a is zero or 1;

B—optionally at least one polyorganosiloxane resin B functionalised by at least one radical R^{fo} corresponding to the definition given above and having, in its structure, at least two different siloxyl units selected from those of formulae (R¹)₃SiO_{1/2} (unit M), (R¹)₂SiO_{2/2} (unit D), R¹SiO_{3/2} (unit T) and SiO₂ (unit Q), at least one of the units being a unit T or Q, the radicals R¹, which are the same or different, having the meanings given above with regard to formula (A), the said resin containing from 0.1 to 10% by weight of functional radicals R^{fo}, it being understood that a portion of the radicals R¹ are radicals R^{fo};

C—optionally at least one crosslinking agent C of formula:

(R²)ₐSi[R^{fo}]₄₋ₐ

wherein R², R^{fo} and a are as defined above,

D—optionally at least one linear non-reactive and non-functionalised R^{fo} polydiorganosiloxane D of formula:

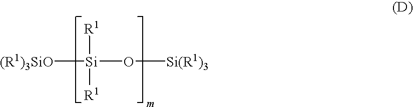

in which:
the substituents R¹ are the same or different and have the same meanings as those provided above for the polyorganosiloxane A of formula (A);
m has sufficient value to give the polymer of formula (D) a dynamic viscosity of from 10 to 200,000 mPa·s at 25° C.;

E—an effective quantity of a vanadium compound E′ and of a titanium compound E″ to act as a crosslinking catalyst or accelerator;

F—a reinforcing and/or semi-reinforcing and/or non-reinforcing filler F;

H—optionally at least one auxiliary agent H.

The vanadium compound E′ may be a vanadium compound with degrees of oxidation of 3 (V³), 4(V⁴) or 5 (V⁵).

In a first embodiment, the compound E′ is a V⁵ compound, and in particular a compound of formula (E′₁): X₃VO in which the radicals X are the same or different and are selected from: the radical ligands X having 1 electron, in particular alkoxy or a halogen atom and the radical ligands LX having 3 electrons, in particular a ligand derived from acetylacetone, a β-ketoester, a malonic ester, an allyl compound, a carbamate, a dithiocarbamate, a carboxylic acid.

The definition of ligands is taken from “Chimie Organométallique” by Didier Astruc, published in 2000 by EDP Sciences. See in particular Chapter 1 “Les complexes monométalliques”, page 31 and following pages.

Alkoxy group refers more specifically to an OR group in which R is a linear or branched C₁-C₁₃ alkyl, in particular C₁-C₈, preferably C₁-C₄, or a C₃-C₈ cylcloalkyl. Examples of V⁵ compounds meeting this description include vanadyl trialkoxylates, preferably the following: [(CH₃)₂CHO]₃VO (vanadium oxotriisopropoxide), (CH₃CH₂O)₃VO, [(CH₃)₃CO]₃VO, [(CH₃CH₂)(CH₃)CHO]₃VO, [(CH₃)₂(CH₂)CHO]₃VO.

Examples of halogen atoms include Cl and Br and F, preferably Cl.

Examples of derivatives of acetylacetone or of an allyl compound include, in particular, acetylacetonato radicals (CH₃COCHCOCH₃) and allyl radicals (CH₂═CH—CH₂).

In a further embodiment, the compound E′ is a V⁴ compound, and in particular a compound of formula (E′₂): X₂VO in which the radicals X are the same or different and are selected from: the radical ligands X having 1 electron, in particular alkoxy or a halogen atom, as described above, and the radical ligands LX having 3 electrons, in particular a ligand derivative of acetylacetone, a β-ketoester, a malonic ester, an allyl compound, a carbamate, a dithiocarbamate, a carboxylic acid.

An example of a compound (E′₂) of this type is VOHa₂ (Ha=halogen, for example, Br, F, Cl, in particular VOCl₂, [(CH₃)₂CHO]₂VO, (CH₃CH₂O)₂VO, [(CH₃)₃CO]₂VO, [(CH₃CH₂)(CH₃)CHO]₂VO, [(CH₃)₂(CH₂)CHO]₂VO.

Examples of derivatives of acetylacetone or of an allyl compound include, in particular, acetylacetonato radicals (CH₃COCHCOCH₃) and allyl radicals (CH₂═CH—CH₂).

In a further embodiment, the compound E′ is a V⁴ compound of formula (E′₃): VX₄ in which X are the same or different and are selected from halogens, in particular Br, F or Cl, and OR alkoxys in which R represents, in particular, a linear or branched C₁-C₁₃, in particular C₁-C₈, preferably C₁-C₄ alkyl, or a C₃-C₈ cycloalkyl.

Examples of a vanadium compound (E′₃) of this type include the following compounds: [(CH₃)₂CHO]₄V, (CH₃O)₄V, (CH₃CH₂O)₄V, [(CH₃)₃CO]₄V, [(CH₃CH₂)(CH₃)CHO]₄V, [(CH₃)₂(CH₂)CHO]₄V.

In a further embodiment, the compound E′ is a V³ compound, and in particular a compound of formula (E′₄): XVO in which the radical X is a radical ligand LX having 3 electrons, in particular a ligand derivative of acetylacetone, a β-ketoester, a malonic ester, an allyl compound, a carbamate, a dithiocarbamate, a carboxylic acid. Examples of derivatives of acetylacetone or of an allyl compound include, in particular, acetylacetonato ligands (CH₃COCHCOCH₃) and allyl ligands (CH₂═CH—CH₂).

In a further embodiment, the compound E′ (E′₅) is a V⁵ compound having radical ligands L₂X with 5 electrons, in particular cyclopentadienyl, for example (C₅H₅)₂V or (C₅H₅)₂VCl₂.

The titanium compound E″ may be an organic titanium derivative selected from the group consisting of:

+monomers E″₁ of formula:

Ti[(OCH₂CH₂)_{c}OR⁷]₄

in which:
the substituents R⁷ are the same or different and each represent a linear or branched C₁ to C₁₂ alkyl radical;
c is zero, 1 or 2;
preferably in conditions in which, when c is zero, the alkyl radical R⁷ has from 2 to 12 carbon atoms, and when c is 1 or 2, the alkyl radical R⁷ has 1 to 4 carbon atoms;
+the polymers E″₂ derived from the partial hydrolysis of the monomers E″₁ in which R⁷ is as defined above when c is zero.

Examples of R⁷ in the organic titanium derivatives E″₁ include the radicals: methyl, ethyl, propyl, iso-propyl, butyl, hexyl, ethyl-2-hexyl, octyl, decyl and dodecyl.

Specific examples of momomers E″₁ include: ethyl titanate, propyl titanate, iso-propyl titanate, butyl titanate, ethyl-2-hexyl titanate, octyl titanate, decyl titanate, dodecyl titanate, β-methoxyethyl titanate, β-ethoxyethyl titanate, β-propoxyethyl titanate, the titanate of formula Ti[(OCH₂CH₂)₂OCH₃]₄. Specific examples of the polymers E″₂ derived from the partial hydrolysis of monomer titanates include: the polymers E″₂ derived from the partial hydrolysis of iso-propyl, butyl or 2-ethyl hexyl titanates.

In order to carry out the invention, the following monomer titanates E″₁ are preferably used, either individually or mixed, as the titanium compound: ethyl titanate, propyl titanate, iso-propyl titanate, butyl titanate (n-butyl).

The composition according to the invention may comprise:
from 0.01 to 1%, preferably from 0.05 to 0.3%, by weight of metallic vanadium;
from 0.01 to 1%, preferably from 0.03 to 0.25%, by weight of metallic titanium,
   these percentages being expressed relative to the weight of the total composition.

The catalyst may be solid or liquid. It may be incorporated alone or in a suitable anhydrous solvent, for example a silicone oil.

The composition according to the invention has all the advantageous inherent properties for this type of product and has, in addition, rapid crosslinking surface and core kinetics, even in the presence of an alkoxy POS and/or a carbonate-based filler. It may be used to produce elastomer parts with conventional thicknesses, i.e. in particular thicknesses from 0.5 or 1 mm to a few centimetres. Particularly in the field of joints, the thickness may be between 0.01 and 2 cm.

In addition, the composition according to the invention is economical and results in crosslinked elastomers endowed with advantageous mechanical properties which adhere to numerous substrates.

The composition according to the invention corresponds to an embodiment in which the basic component, i.e. the POS A is functionalised at its ends (generally initially carrying hydroxyl groups) by functionalisation radicals R^{fo} producing a silane crosslinking agent C. The OH of the precursor of the POS A reacted with the R^{fo} of the silane crosslinking agent C, by means of condensation.

The POS A is functionalised by methods known to the person skilled in the art. The functionalised POS A is, in the absence of moisture, a stable form of the single-component mastic discussed in the present case. In practice this stable form is that of the composition packaged in hermetically-sealed containers which will be opened by the operator during use and which allow the operator to apply the mastic to all the desired substrates.

The R^{fo} functionalised hydroxylated precursor A′ to the POS A is generally a α,ω-hydroxylated polydiorganosiloxane of formula:

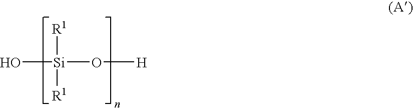

wherein R² and n are as defined above in formula (A).

The optional R^{fo} functionalised POS resin B may be produced in the same way as R^{fo} functionalised POS A by condensation with a silane crosslinking agent C carrying functionalisation radicals R^{fo}.

The precursor to the R^{fo} functionalised POS resin B may be a hydroxylated POS resin B′ according to the definition provided above for B, the difference being that a portion of the radicals R¹ correspond to OH.

The composition according to the invention may be of the acid type (acetoxy . . . ) or of the neutral type (enoxy, oxime, alkoxy . . . ).

According to a preferred embodiment of the invention, the silicone composition concerned is rather of the neutral type, for example oxime or alkoxy, which means that the functionalisation substituents R^{fo} of formulae A, B and C are the same or different and each represent:
an oxime radical of formula:

(R³)₂C═N—O—
wherein R³ independently represents a linear or branched C₁ to C₈ alkyl; a C₃ to C₈ cycloalkyl, a C₂ to C₈ alkenyl, preferably selected from the group comprising: methyl, ethyl, propyl, butyl, vinyl, allyl;
and/or an alkoxy radical of formula:

R⁴O(CH₂CH₂O)_{b}—
wherein R⁴ independently represents a linear or branched C₁ to C₈ alkyl; a C₁ to C₈ cycloalkyl; preferably selected from the group comprising: methyl, ethyl, propyl, butyl, methylglycol, and b=0 or 1.

In a preferred embodiment of the invention, the functionalisation substituents R^{fo} are of the alkoxy type and correspond to formula R⁴O(OCH₂CH₂)_{b} as defined above.

Examples of auxiliaries H or additives which are particularly beneficial for the composition according to the invention include adhesion promoters.

Thus the POS composition according to the invention may comprise at least one adhesion promoter H1, which is in particular non-nucleophilic and non-aminated, or is a tertiary amine, preferably selected from organosilicon compounds simultaneously carrying:
(1) one or more hydrolysable groups linked to the silicon atom and
(2) one or more organic groups substituted by radicals selected from the group of (meth)acrylate, epoxy, and alkenyl radicals, and more preferably from the group comprising:
   vinyltrimethoxysilane (VTMO),
   (3-glycidoxypropyl)trimethoxysilane (GLYMO),
   methacryloxypropyltrimethoxysilane (MEMO),
   propyltrimethoxysilane,
   methyltrimethoxysilane,
   ethyltrimethoxysilane,
   vinyltriethoxysilane,
   methyltriethoxysilane,
   propyltriethoxysilane,
   tetraethoxysilane,
   tetrapropoxysilane,
   tetraisopropoxysilane,
      or polyorganosiloxane oligomers having organic groups of this type in a content of greater than 20%.

It is also possible to use a silicate carrying one or more hydrolysable groups, specifically alkyl groups, typically from 1 to 8 C, as an adhesion promoter. Examples include propyl silicates, iso-propyl silicates and ethyl silicates. The silicates may be either polycondensed or non-polycondensed.

In order to describe the nature of the constituent elements of the composition according to the invention in greater detail, it is important to specify that the substituents R¹ of the functionalised POS polymers A, the R^{fo} functionalised resins B and the optional non-functionalised polymers D may be selected from the group:
alkyl and halogenoalkyl radicals having from 1 to 13 carbon atoms,
cycloalkyl and halogenocycloalkyl radicals having from 5 to 13 carbon atoms,
alkenyl radicals having from 2 to 8 carbon atoms,
mononuclear aryl and halogenoaryl radicals having from 6 to 13 carbon atoms,
cyanoalkyl radicals, of which the alkyl members have 2 to 3 carbon atoms,
   methyl, ethyl, propyl, iso-propyl, n-hexyl, phenyl, vinyl and 3,3,3-trifluoropropyl radicals being particularly preferred.

More specifically, and without thereby entailing any limitations, the substituents R¹ mentioned hereinbefore for the POS polymers A and D (optional) comprise:
alkyl and halogenoalkyl radicals having from 1 to 13 carbon atoms such as methyl, ethyl, propyl, iso-propyl, butyl, pentyl, hexyl, ethyl-2-hexyl, octyl, decyl, trifluoro-3,3,3-propyl, trifluoro-4,4,4-butyl, pentafluoro-4,4,4,3,3-butyl radicals,
cycloalkyl and halogenocycloalkyl radicals having from 5 to 13 carbon atoms such as cyclopentyl, cyclohexyl, methylcyclohexyl, propylcyclohexyl, difluoro-2,3-cyclobutyl, difluoro-3,4-methyl-5-cycloheptyl radicals,
alkenyl radicals having from 2 to 8 carbon atoms such as vinyl, allyl, buten-2-yl radicals,
mononuclear aryl and halogenoaryl radicals having from 6 to 13 carbon atoms, such as phenyl, tolyl, xylyl, chlorophenyl, dichlorophenyl, trichlorophenyl radicals,
cyanoalkyl radicals, of which the alkyl members have 2 to 3 carbon atoms such as β-cyanoethyl and γ-cyanopropyl radicals.

Specific examples of the siloxyl units D: (R¹)₂SiO_{2/2} present in the R^{fo} functionalised diorganopolysiloxanes A of formula (A) and in the optional non-reactive diorganopolysiloxanes D of formula (D) include:

(CH₃)₂SiO,

CH₃(CH₂═CH)SiO,

CH₃(C₆H₅)SiO,

(C₆H₅)₂SiO,

CF₃CH₂CH₂(CH₃)SiO,

NC—CH₂CH₂(CH₃)SiO,

NC—CH(CH₃)CH₂(CH₂═CH)SiO,

NC—CH₂CH₂CH₂(C₆H₅)SiO.

It should be understood that, within the scope of the present invention, a mixture consisting of a plurality of polymers—preferably initially hydroxylated and subsequently R^{fo} functionalised—which differ from one another in terms of their viscosity values and/or the nature of the substituents linked to the silicon atoms may be used as functionalised polymers A of formula (A). It should also be pointed out that the functionalised polymers A of formula (A) may optionally comprise siloxyl units T of formula R¹SiO_{3/2} and/or siloxyl units Q: SiO_{4/2}, in a proportion of more than 1% (this percentage expressing the number of units T and/or Q per 100 silicon atoms). The same applies to the non-functionalised and non-reactive polymers D (optional) of formula (D).

The substituents R¹ of the functionalised polymers A and the non-reactive and non-functionalised polymers D (optional) which are advantageously used due to their availability in industrial products are methyl, ethyl, propyl, iso-propyl, n-hexyl, phenyl, vinyl and 3,3,3-trifluoropropyl radicals. More advantageously, at least 80% by number of these substituents are methyl radicals.

Functionalised polymers A having a dynamic viscosity at 25° C. of from 500 to 1,000,000 mPa·s, and preferably of from 2,000 to 200,000 mPa·s are used.

Non-functionalised polymers D (optional) having a dynamic viscosity at 25° C. of from 10 to 200,000 mPa·s, and preferably of from 50 to 150,000 mPa·s are utilised.

When the non-reactive and non-functionalised polymers D are used, they may be introduced in their entirety or in a plurality of fractions and over a plurality of stages or in a single stage of preparation of the composition. The optional fractions may be the same or different in terms of their nature and/or proportions. Preferably, D is introduced in its entirety in a single stage.

Examples of suitable or advantageous substituents R¹ of R^{fo} functionalised POS resins B include the various radicals R¹ of the type mentioned hereinbefore for functionalised polymers A. These silicone resins are well-known branched polyorganosiloxane polymers, the preparation processes of which are described in numerous patents. Specific examples of resins that may be used include MQ, MDQ, TD and MDT resins.

Examples of resins that may be used are preferably R^{fo} functionalised POS resins B which do not have the unit Q in their structure. More preferably, examples of resins that may be used include functionalised TD and MDT resins comprising at least 20% by weight of the units T and having a R^{fo} group content of from 0.3 to 5% by weight. Even more preferably, resins of this type are used, in which at least 80% by number of the substituents R¹ in the structure are methyl radicals. The functional groups R^{fo} of the resins B may be carried by the units M, D and/or T.

Specific examples of substituents R² which are particularly suitable for the functionalised POS A and the crosslinking agents C are the same radicals as those mentioned hereinbefore for the substituents R¹ of the functionalised polymers A.

In terms of the substituents R³, R⁴, R⁵ which constitute the functionalisation radicals R^{fo}, it has been found that that C₁-C₄ alkyl radicals, such as methyl, ethyl, propyl, iso-propyl and n-butyl radicals are particularly suitable.

According to a preferred embodiment of the composition according to the invention, the radicals R^{fo} used for functionalising the POS which is initially hydroxylated are of the alkoxy type and more preferably are derived from the silane crosslinking agents C selected from the group comprising

Si(OCH₃)₄

Si(OCH₂CH₃)₄

Si(OCH₂CH₂CH₃)₄

(CH₃O)₃SiCH₃

(C₂H₅O)₃SiCH₃

(CH₃O)₃Si(CH═CH₂)

(C₂H₅O)₃Si(CH═CH₂)

(CH₃O)₃Si(CH₂—CH═CH₂)

(CH₃O)₃Si[CH₂—(CH₃)C═CH₂]

(C₂H₅O)₃Si(OCH₃)

Si(OCH₂—CH₂—OCH₃)₄

CH₃Si(OCH₂—CH₂—OCH₃)₃

(CH₂═CH)Si(OCH₂CH₂OCH₃)₃

C₆H₅Si(OCH₃)₃

C₆H₅Si(OCH₂—CH₂—OCH₃)₃.

According to an embodiment of the invention, the composition comprising the POS A and the catalyst may also comprise at least one crosslinking agent C as described above.

The filler F may be present in quantities of from 5 to 50% by weight, preferably between 15 and 40%, based on the total composition

According to a first embodiment, the filler F comprises at least one carbonate-based filler acting as a reinforcing or semi-reinforcing filler.

Carbonate-based filler refers to a filler comprising at least an alkaline or alkaline-earth metal, preferably an alkaline-earth metal carbonate, preferably calcium carbonate. Fillers having a mean particle size of less than or equal to 0.5 μm are preferably used. Industrial carbonates such as precipitation carbonates, for example precipitation calcium carbonate, may be used in particular. Under these conditions, it is possible to have access to carbonates of which the mean particle size is generally less than 1 μm, in particular less than or equal to 0.5 μm. These precipitation carbonates may thus have a high BET specific surface area, which is greater than 5 m²/g. Carbonates of this type having a mean particle size or particle size distribution of less than or equal to 0.1 μm, more preferably between 0.01 and 0.1 μm, and preferably having a BET specific surface area of from 10 to 70 m²/g, preferably of from 15 to 30 m²/g are preferably used. The carbonates used may contain a specific quantity of residual hydration moisture, which is generally approximately 0.1 to 0.6%.

The carbonates according to the invention are treated, in particular with carboxylic fatty acids such as stearic acid as known per se to improve the dispersability of the carbonates in a hydrophobic medium, in a particularly preferred manner.

According to a second embodiment, the filler F comprises at least one siliceous reinforcing filler, specifically an amorphous silica. In terms of the amorphous silicas which may be used according to the invention, all the precipitation or pyrogenic silicas (or combustion silicas) known to a person skilled in the art are suitable. It is of course possible to use cuts of various silicas. These silicas may have a mean particle size of less than or equal to 0.1 μm.

Precipitation silicas in powdered form, combustion silicas in powdered form or mixtures of the two are preferably used; their BET specific surface area is generally greater than 40 m²/g and preferably between 100 and 300 m²/g; combustion silicas in powdered form are preferably used.

These siliceous fillers may be surface-modified by treating them with various organosilicon compounds conventionally used for this purpose. These organosilicon compounds may therefore be organochlorosilanes, diorganocyclopolysiloxanes, hexaorganodisiloxanes, hexaorganodisilazanes, or diorganocyclopolysilazanes (patents FR 1 126 884, FR 1 136 885, FR 1 236 505, GB 1 024 234). In the majority of cases, the treated fillers contain from 3 to 30% of their weight of organosilicon compounds.

Examples of other siliceous fillers include quartz and silicas or diatomaceous earth having a mean particle size of less than or equal to 0.1 μm.

In the present application, the viscosity of the oils is a Newtonian dynamic viscosity measured at 25° C. with the aid of a Brookfield viscometer according to details given by the Afnor standard NFT 76102 of May 1982.

The BET specific surface area is determined according to the Brunauer, Emmet and Teller method described in “The Journal of American Chemical Society”, vol. 80, page 309 (1938) corresponding to Afnor standard NFT 45007 of November 1987.

The scope of the invention also includes a combination of a carbonate-based filler and a siliceous filler, in particular silica.

Using or combining further fillers, such as non-reinforcing or semi-reinforcing fillers, also falls within the scope of the present invention. Examples include white opacifying fillers such as titanium or aluminium oxides, carbon black fillers; powdered quartz, diatomaceous silicas, calcined clay, titanium oxide (rutile), iron oxides, zinc oxides, chromium oxides, zirconium oxides, magnesium oxides, various forms of aluminium (hydrated or non-hydrated), boron nitride, lithopone, barium metaborate, cork powder, saw dust, phthalocyanines, organic and mineral fibres, organic polymers (polytetrafluoroethylene, polyethylene, polypropylene, polystyrene, vinyl polychloride). In practice, these additional fillers may be in the form of mineral and/or organic products which are more roughly ground and have a mean particle size greater than 0.1 μm, in particular greater than 1 μm and generally approximately from 10 to tens of μm.

Natural carbonates such as natural calcium carbonate may be used, the particle size being generally greater than 1 μm, and mean particle sizes of less than or equal to 10 μm, for example between 1 and 10 μm being preferred within the scope of the present invention.

The object of adding fillers is to confer good mechanical and rheological characteristics to the elastomers derived from the compositions according to the invention.

Inorganic and/or organic pigments and agents for improving thermal resistance (rare earth salts and oxides such as ceric oxides and ceric hydroxides) and/or flame resistance may also be used in combination with the above fillers. Agents which improve flame resistance include organic halogenated derivatives, organic phosphorus derivatives, platinum derivatives such as chloroplatinic acid (the products of its reaction with alkanols, ether oxides), platinum chloride olefin complexes.

According to a preferred feature of the invention, the single-component POS comprises:
100 parts by weight of linear diorganopolysiloxane(s) A functionalised by R^{fo},
from 0 to 30, preferably 5 to 15, parts by weight of hydroxylated resin(s) B,
from 2 to 15, preferably 3.5 to 12, parts by weight of crosslinking agent(s) C,
from 0 to 60, preferably from 5 to 60, parts by weight of linear, non-functionalised and non-reactive diorganopolysiloxane(s) D,
from 0.1 to 10, preferably 0.5 to 6, parts by weight of crosslinking/hardening catalyst E′+E″,
from 2 to 250, preferably from 10 to 200, parts by weight of filler, for example a carbonate and/or silica-based filler F, and
from 0 to 20, specifically from 0.1 to 20, preferably from 0.1 to 10, parts by weight of adhesion promoter H.

Other conventional auxiliary agents and additives H may be added to the composition according to the invention; they are selected according to the applications in which the said compositions will be used.

The compositions according to the invention harden at ambient temperature and specifically at temperatures between 5 and 35° C. in the presence of moisture.

These compositions may be used in many applications such as joining in the construction industry, assembling and gluing a very wide range of materials (metals; plastics materials such as PVC, PMMA; natural and synthetic rubbers; wood; cardboard; earthenware; brick; glass; stone; concrete; masonry elements), not only in the construction industry but also in the automotive, household-appliance and electronics industries.

According to another of its aspects, the present invention also relates to an elastomer, in particular an elastomer which can adhere to different substrates and is obtained through crosslinking and hardening of the composition of the single-component silicone mastic described hereinbefore containing a vanadium compound and a titanium compound as described above.

The single-component organopolysiloxane compositions according to the present invention are prepared in the absence of moisture in a closed reactor which is equipped with a stirrer. A vacuum may be created in the reactor as required and the expelled air subsequently replaced by an anhydrous gas, such as nitrogen.

Examples of apparatus include: slow mixing arms, paddle mixers, pug mills, arm-type mixers, anchor mixers, planetary mixers, hook mixers, single-screw or multi-screw extruders.

The invention further relates to the use of a vanadium compound and a titanium compound as a catalyst for a polyorganosiloxane (POS) composition which is stable in storage in the absence of moisture and crosslinks into an elastomer in the presence of water, the composition comprising at least one crosslinkable linear polyorganopolysiloxane POS and a reinforcing and/or semi-reinforcing and/or a non-reinforcing filler, in particular a carbonate-based filler, the POS having non-hydroxylated functionalised ends, in particular ends of the alkoxy, oxime, acyl and/or enoxy type, preferably the alkoxy type, the composition being basically, preferably entirely, free of POS having hydroxylated ends. Within the scope of this use, the vanadium and titanium compounds, POS, filler and other optional components, in their various embodiments, are as described above.

A better understanding of the invention will be facilitated by the following non-limiting examples.

### EXAMPLES

### Comparative Example 1

### Formulation of a RTV1 Catalysed by a Titanium-Based Catalyst

677 g of α, ω-hydroxylated polydimethylsiloxane oil with a viscosity of approximately 20,000 mPa·s, 66 g of α, ω-trimethylsilylated polydimethylsiloxane oil with a viscosity of approximately 100 mPa·s, 55 g of a black colour base (this colour base consists of 83% of α, ω-trimethylsilylated polydimethylsiloxane oil and 17% of carbon black), 7.42 g of Breox B225®, a thixotropy agent sold by Laporte Performance Chemicals and 67.6 g of vinyltrimethoxysilane are introduced into the interior chamber of a uniaxial “butterfly” mixer. The contents are mixed at 140 rpm for approximately 5 minutes and 6 g of a lithium hydroxide-based functionalisation catalyst are added to the chamber. The mixture is stirred for 5 minutes at 330 rpm to allow the functionalisation reaction to take place. 28.9 g of amorphous silica sold by Degussa under the name AE150® are subsequently added, initially at a reduced stirring speed (140 rpm), then at a faster speed (330 rpm for 5 minutes) to ensure it is fully dispersed in the mixture. 421 g of treated calcium carbonate, sold by Solvay under the name Winnofil SPM® are then added. The calcium carbonate is dispersed in the formulation by active stirring (330 rpm) for 6 minutes. The mixture then undergoes a first phase of devolatilisation for 6 minutes in a vacuum of approximately 60 mbar with moderate stirring (140 rpm). 23 g of a mixture containing 16.7% by mass of methacryloxypropyltrimethoxysilane (MEMO) and 83.3% of butyl titanate (TBOT) are then added. After 4 min of mixing at 330 rpm, the medium is devolatilised for 6 min, in a vacuum of approximately 60 mbar and subject to reduced stirring at 140 rpm before being packaged in containers.

The characteristics of the formulation thus produced are summarised in Table 1 under the heading “comparative”.

### Example 2

### Formulation of a Co-Catalysed RTV1

A plurality of tests 1 to 6 were carried out using a co-catalytic titanium and vanadium-based system. The tests followed the same mode of operation as example 1, differing only in terms of the composition of the mixture added after the first devolatilisation stage. This mixture comprises MEMO, TBOT and vanadium oxotriisopropoxide in proportions which result in formulations of which the respective contents of each of these three components are shown in Table 1. In this table, the contents of these components in the formulation of the comparative example 1 are also shown, when they are present.

TABLE 1

| | | | % vanadium |
|---|---|---|---|
| Test reference | % MEMO | % TBOT | triisopropoxide |
| comparative | 0.29 | 1.4 | 0 |
| 1 | 0.29 | 1.4 | 0.98 |
| 2 | 0.29 | 1.02 | 0.73 |
| 3 | 0.29 | 0.68 | 0.49 |
| 4 | 0.29 | 1.36 | 0.49 |
| 5 | 0.29 | 0.68 | 0.98 |
| 6 | 0.29 | 1.36 | 0.98 |

Results: The results describing the crosslinking kinetics of all the formulations are summarised in Table 2.

There are three properties through which the crosslinking kinetics can be evaluated:
The Skin Formation Time (SFT) which shows the speed of surface curing.
Shore A hardness after 24 hours (DSA 24 h)
Shore A hardness after 7 days (DSA 7 d)

The two latter properties provide a comprehensive picture of the state of progress of elastomer network formation after 24 hours and 7 days respectively. Their ratio directly represents the crosslinking kinetics for a given formulation.

TABLE 2

| | Catalyst | SFT | DSA | DSA | |
|---|---|---|---|---|---|
| Reference | type | (min) | 24 h | 7 d | DSA 24 h/DSA 7 d |
| comparative | Ti | 23 | 34 | 37 | 0.92 |
| 1 | Ti/V | 3 | 31 | 40 | 0.78 |
| 2 | Ti/V | 5 | 32 | 41 | 0.78 |
| 3 | Ti/V | 11 | 29 | 40 | 0.73 |
| 4 | Ti/V | 11 | 32 | 40 | 0.80 |
| 5 | Ti/V | 4 | 33 | 41 | 0.81 |
| 6 | Ti/V | 4 | 32 | 41 | 0.78 |

It is clear from Table 2 that using a co-catalytic Ti and V-based system improves crosslinking kinetics. The titanium catalyst thus allows a network to be constructed effectively as seen from the changes in DSA, but is unacceptably slow in terms of surface curing. The combination of the two metals results in a distinct improvement in surface curing accompanied by good progress of the DSA.

It should be understood that the invention defined by the appended claims is not limited to the particular embodiments mentioned in the description above, but encompasses variants that do not depart from the scope or spirit of the present invention.

1-11. (canceled)

12. A single-component polyorganosiloxane composition (POS) which is stable in storage in the absence of moisture and crosslinks into an elastomer in the presence of water, the composition comprising at least one crosslinkable linear polyorganopolysiloxane POS, a filler and a crosslinking catalyst, the POS having functionalized alkoxy, oxime, acyl and/or enoxy endgroups, said composition essentially being free of hydroxylated POS and the catalyst comprises a vanadium compound and a titanium compound.

13. The POS composition as defined by claim 12, comprising:
(A) at least one crosslinkable linear polyorganopolysiloxane A of formula: 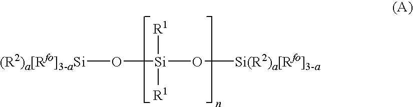
in which:
the substituents R¹ are the same or different and each represent a monovalent saturated or unsaturated C₁ to C₁₃ hydrocarbon radical which may be substituted or unsubstituted, aliphatic, cyclanic or aromatic:
the substituents R² are the same or different and each represent a monovalent saturated or unsaturated C₁ to C₁₃ hydrocarbon radical which may be substituted or unsubstituted, aliphatic, cyclanic or aromatic:
the functionalization substituents R^{fo} are the same or different and each represent:
an oxime radical of formula:
(R³)₂C═N—O—
wherein R³ independently represents a linear or branched C₁ to C₈ alky radical, a C₃ to C₈ cycloalkyl radical, a C₂ to C₈ alkenyl radical,
an alkoxy radical of formula:
R⁴O(CH₂CH₂O)_{b}—
wherein R⁴ independently represents a linear or branched C₁ to C₈ alkyl radical, a C₃ to C₈ cycloalkyl radical, and b=0 or 1;
an acyl radical of formula: 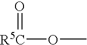
wherein R⁵ represents a monovalent saturated or unsaturated C₁ to C₁₃ hydrocarbon radical which may be substituted or unsubstituted, aliphatic, cyclanic or aromatic,
an enoxy radical of formula:
R⁶R⁶C═C R⁶—O—
wherein R⁶ are the same or different and each represent hydrogen or a monovalent saturated or unsaturated C₁ to C₁₃ hydrocarbon radical which may be branched or unbranched, substituted or unsubstituted, aliphatic, cyclanic or aromatic;
n has sufficient value to give POS A a dynamic viscosity of from 500 to 1,000,000 mPa·s at 25° C.;
a is zero or 1;
(B) optionally, at least one polyorganosiloxane resin B functionalized by at least one radical R^{fo} as defined above and having, in its structure, at least two different siloxyl units selected from among those of formulae (R¹)₃SiO_{1/2} (unit M), (R¹)₂SiO_{2/2} (unit D), R¹ SiO_{3/2} (unit T) and SiO₂ (unit Q), at least one of the units being a unit T or Q, the radicals R¹, which are the same or different, having the definitions given above with regard to formula (A), the said resin having a content by weight of functional radicals R^{fo} from 0.1 to 10%, with the proviso that a portion of the radicals R¹ are radicals R^{fo};
(C) optionally, at least one crosslinking agent C of formula:
(R²)ₐSi[R^{fo}]₄₋ₐ
wherein R², R^{fo} and a are as defined above,
(D) optionally, at least one linear polydiorganosiloxane D which is non-reactive and non-functionalized R^{fo} of formula: 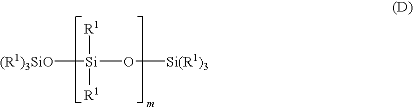
in which:
the substituents R¹ are the same or different and have the same definitions as given above for the polyorganosiloxane A of formula (A);
m has a sufficient value to give the polymer of formula (D) a dynamic viscosity of from 10 to 200,000 mPa·s at 25° C.;
(E) an effective amount of a vanadium compound E′ and of a titanium compound E″ as a crosslinking catalyst or accelerator;
(F) a filler F; and
(H) optionally, at least one auxiliary agent H.

14. The POS composition as defined by claim 12, wherein the POS A has alkoxy endgroups.

15. The POS composition as defined by claim 13, wherein the filler F comprises a siliceous or carbonate-based reinforcing or semi-reinforcing filler.

16. The POS composition as defined by claim 13, wherein the vanadium compound comprises a vanadyl trialkoxylate.

17. The POS composition as defined by claim 13, wherein the vanadium compound is selected from the group consisting of: [(CH₃)₂CHO]₃VO (CH₃CH₂O)₃VO, [(CH₃)₃CO]₃VO, [(CH₃CH₂)(CH₃)CHO]₃VO, [(CH₃)₂(CH₂)CHO]₃VO, VOCl₂, [(CH₃)₂CHO]₂VO, (CH₃CH₂O)₂VO, [(CH₃)₃CO]₂VO, [(CH₃CH₂)(CH₃)CHO]₂VO, [(CH₃)₂(CH₂)CHO]₂VO, [(CH₃)₂CHO]₄V, (CH₃O)₄V, (CH₃CH₂O)₄V, [(CH₃)₃CO]₄V, [(CH₃CH₂)(CH₃)CHO]₄V and [(CH₃)₂(CH₂)CHO]₄V.

18. The POS composition as defined by claim 13, wherein the titanium compound has the following formula:
Ti[OCH₂CH₂)_{c}OR⁷]₄
in which:
the substituents R⁷ are the same or different and each represents a linear or branched C₁ to C₁₂ alkyl radical;
c is zero, 1 or 2;
preferably with the proviso that, when c is zero, the alkyl radical R⁷ has from 2 to 12 carbon atoms, and when c is 1 or 2, the alkyl radical R⁷ has 1 to 4 carbon atoms;
or a polymer resulting from the partial hydrolysis of these momomers when c is zero.

19. The POS composition as defined by claim 13, wherein the titanium compound is selected from the group consisting of:
ethyl titanate, propyl titanate, iso-propyl titanate, butyl titanate, 2-ethylhexyl titanate, octyl titanate, decyl titanate, dodecyl titanate, beta-methoxyethyl titanate, beta-ethoxyethyl titanate, beta-propoxyethyl titanate, the titanate of formula Ti[(OCH₂CH₂)₂OCH₃]₄, polymers resulting from the partial hydrolysis of isopropyl, butyl or 2-ethylhexyl titanates.

20. The POS composition as defined by claim 12, comprising:
from 0.01 to 1% by weight of metallic vanadium;
from 0.01 to 1% by weight of metallic titanium.

21. The POS composition as defined by claim 13, wherein the substituents R¹ of the functionalized POS polymers A, the R^{fo} functionalized resins B and the optional non-functionalised and non-reactive polymers D are selected from the group consiting of:
alkyl and halogenoalkyl radicals having from 1 to 13 carbon atoms,
cycloalkyl and halogenocycloalkyl radicals having from 5 to 13 carbon atoms,
alkenyl radicals having from 2 to 8 carbon atoms,
mononuclear aryl and halogenoaryl radicals having from 6 to 13 carbon atoms, and
cyanoalkyl radicals, of which the alkyl moieties have 2 to 3 carbon atoms.

22. An elastomer that adheres to a variety of substrates, obtained by crosslinking and hardening the POS composition as defined by claim 12.
